(19) United States
(12) Patent Application Publication
(10) Pub. No.: US 2026/0251504 A1
(43) Pub. Date: Aug. 27, 2026

(54) IN SITU PRESSURE MONITORING OF INFRARED IMAGING ASSEMBLIES

(71) Applicant: Raytheon Company, Arlington, VA (US)

(72) Inventors: Paul Thomas Fini, Santa Barbara, CA (US); Craig R. Adams, Buellton, CA (US)

(21) Appl. No.: 19/381,973

(22) Filed: Nov. 6, 2025

Related U.S. Application Data
(60) Provisional application No. 63/762,368, filed on Feb. 24, 2025.

(51) Int. Cl. G01J 5/061; G01J 5/06; G01J 5/20

(52) U.S. Cl. CPC G01J 5/061; G01J 5/064; G01J 5/20

(57) ABSTRACT

An infrared imaging assembly may include a vacuum dewar assembly and an infrared sensor chip assembly (SCA) housed within the vacuum dewar assembly. The infrared imaging assembly may also include a sensor housed within the vacuum dewar assembly. The sensor may be configured to measure a pressure level within the vacuum dewar assembly. The infrared imaging assembly may further include a cooler configured to provide a cryogenic SCA temperature within the vacuum dewar assembly.

### CROSS-REFERENCE TO RELATED APPLICATION AND PRIORITY CLAIM

This application claims priority under 35 U.S.C. § 119(e) to U.S. Provisional Patent Application No. 63/762,368 filed on February 24, 2025, which is hereby incorporated by reference in its entirety.

### TECHNICAL FIELD

This disclosure generally relates to imaging devices. More specifically, this disclosure relates to in situ pressure monitoring of infrared imaging assemblies.

### BACKGROUND

Infrared sensor chip assemblies (SCAs) within existing infrared imaging systems typically operate at cryogenic temperatures, such as approximately 80 degrees Kelvin. This is made possible by thermally isolating an infrared SCA within a vacuum dewar assembly. A sufficiently low pressure (alternately termed high vacuum) level enables optimal SCA operation at cryogenic temperature by preventing convective heat transfer. For example, a cooler (such as a cryocooler or cryostat) can often be thermally coupled to an infrared SCA within a vacuum dewar assembly, and the cryocooler can be used to remove thermal energy from the infrared SCA while leaving the exterior of the assembly at ambient temperature.

### SUMMARY

This disclosure relates to in situ pressure monitoring of infrared imaging assemblies.

In some examples, an infrared imaging assembly may include a vacuum dewar assembly and an infrared sensor chip assembly (SCA) housed within the vacuum dewar assembly. The infrared imaging assembly may also include a sensor housed within the vacuum dewar assembly. The sensor may be configured to measure a pressure level within the vacuum dewar assembly. The infrared imaging assembly may further include a cooler configured to provide a cryogenic SCA temperature within the vacuum dewar assembly.

Any single one or any combination of the following features may be used with the above examples. The sensor may be one of a micro-electro-mechanical system (MEMS) Pirani gauge or a MEMS ionization gauge. The infrared SCA and the sensor may be jointly mounted to a platform internal to the vacuum dewar assembly. The sensor may be mounted to an internal surface of the vacuum dewar assembly other than an SCA platform. The infrared assembly may include a control circuit. The control circuit may be configured to prevent operation of the cooler if a pressure level measured by the sensor exceeds a predetermined pressure limit. The control circuit may be configured to transmit an error signal if the pressure level measured by the sensor exceeds the predetermined pressure limit. The sensor may be further configured to measure a temperature within the vacuum dewar assembly. The infrared imaging assembly may include at least one electrical feedthrough configured to provide a signal from the sensor to an exterior of the vacuum dewar assembly.

In other examples, a vacuum dewar assembly for an infrared imaging assembly may include an infrared SCA housed within the vacuum dewar assembly and a sensor housed within the vacuum dewar assembly. The sensor may be configured to measure a pressure level within the vacuum dewar assembly.

Any single one or any combination of the following features may be used with the above examples. The sensor may be one of a MEMS Pirani gauge or a MEMS ionization gauge. The infrared SCA and the sensor may be jointly mounted to a platform internal to the vacuum dewar assembly. The sensor may be mounted to an internal surface of the vacuum dewar assembly other than an SCA platform. The sensor may be configured to measure a temperature within the vacuum dewar assembly. The vacuum dewar assembly may include at least one electrical feedthrough configured to provide a signal from the sensor to an exterior of the vacuum dewar assembly.

In still other examples, a method may include measuring, via a sensor housed within a vacuum dewar assembly of an infrared imaging assembly, a pressure level within the vacuum dewar assembly. The method may also include determining whether the pressure level within the vacuum dewar assembly exceeds a predetermined pressure limit. The method may further include, in response to a determination that the pressure level within the vacuum dewar assembly does not exceed the predetermined pressure limit, and in response to a determination that the pressure level within the vacuum dewar assembly exceeds the predetermined pressure limit, initiating an action.

Any single one or any combination of the following features may be used with the above examples. The action may be transmitting an error signal. The sensor may be one of a MEMS Pirani gauge or a MEMS ionization sensor. The infrared imaging assembly may include the vacuum dewar assembly, an infrared SCA housed within the vacuum dewar assembly, the sensor, and a cooler configured to provide a cryogenic SCA temperature within the vacuum dewar assembly. The sensor may be further configured to measure a temperature within the vacuum dewar assembly. The method may further include measuring, via the sensor, a temperature within the vacuum dewar assembly, determining whether the temperature within the vacuum dewar assembly exceeds a predetermined temperature limit, and in response to a determination that the temperature within the vacuum dewar assembly exceeds the predetermined temperature limit, initiating an action. The action may be transmitting an error signal.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A through 1D illustrate an example dewar-cooler assembly in accordance with this disclosure;

FIG. 2 illustrates an example schematic diagram for an infrared imaging assembly in accordance with this disclosure; and

FIG. 3 illustrates an example method of evaluating a vacuum status of an infrared imaging assembly in accordance with this disclosure.

### DETAILED DESCRIPTION

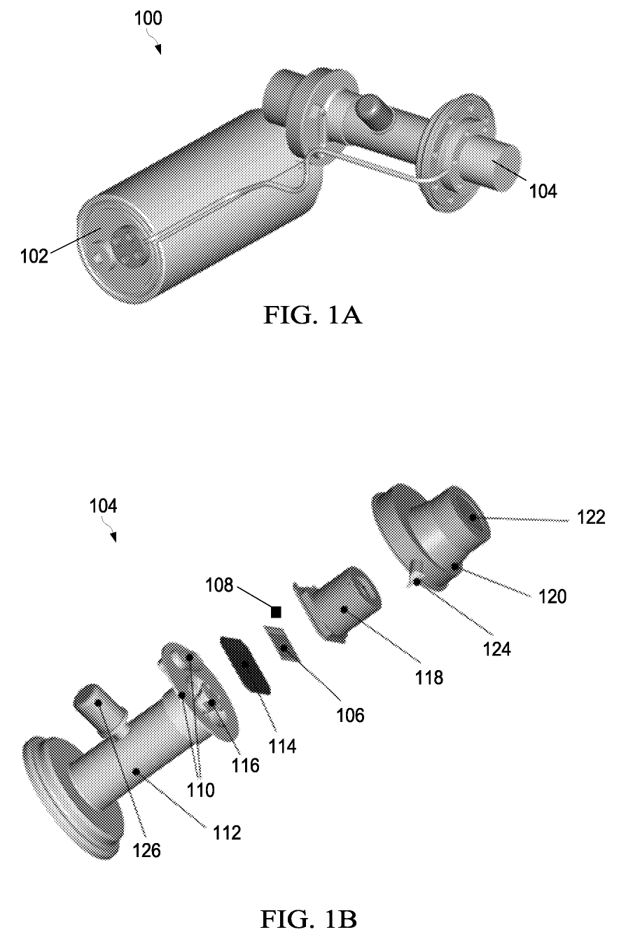

FIGS. 1A through 3, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, infrared sensor chip assemblies (SCAs) within existing infrared imaging systems typically operate at cryogenic temperatures, such as approximately 80 degrees Kelvin. This is made possible by thermally isolating an infrared SCA within a vacuum dewar assembly. A sufficiently low pressure (alternately termed high vacuum) level enables optimal SCA operation at cryogenic temperature by preventing convective heat transfer. For example, a cooler (such as a cryocooler or cryostat) can often be thermally coupled to an infrared SCA within a vacuum dewar assembly, and the cryocooler can be used to remove thermal energy from the infrared SCA while leaving the exterior of the assembly at ambient temperature. Unfortunately, the pressure (vacuum) level within the dewar assembly is generally not monitored after its final assembly and hermetic sealing. As a result, a slow leak may raise the internal dewar pressure and severely compromise performance via infrared SCA cooldown time failure and/or an inability to reach cryogenic temperature. This disclosure provides various devices, systems, and methods for measuring vacuum levels within dewars that are part of infrared imaging assemblies.

FIGS. 1A through 1D illustrate an example dewar-cooler assembly 100 in accordance with this disclosure. More specifically, FIG. 1A illustrates a perspective view of the dewar-cooler assembly 100, FIG. 1B illustrates an exploded perspective view of a vacuum dewar assembly of the dewar-cooler assembly 100, and FIG. 1C illustrates an alternate view of some subcomponents of the dewar assembly of the dewar-cooler assembly 100. FIG. 1D illustrates the view of FIG. 1C with an alternative component arrangement.

As can be seen in FIGS. 1A through 1D, the dewar-cooler assembly 100 includes a cooler 102 and a vacuum dewar assembly 104 that houses an infrared SCA 106 and a sensor 108. The vacuum dewar assembly 104 is configured to maintain a vacuum environment for the infrared SCA 106 so that the cooler 102 may efficiently provide a cryogenic temperature within the vacuum dewar assembly 104 to cool the infrared SCA 106. The cooler 102 may be a cryocooler, a cryostat, or any other suitable cooler. The sensor 108 is configured to measure a pressure level within the vacuum dewar assembly 104. In some embodiments, the sensor 108 may be a miniaturized sensor. For example, the sensor 108 may be a micro-electro-mechanical system (MEMS) sensor. In some embodiments, the sensor 108 may be a MEMS sensor that acts as a Pirani gauge, which measures resistance or voltage changes of a heated element depending on its cooling by at least one ambient gaseous species. In some embodiments, the sensor 108 may be a MEMS sensor that acts as an ionization sensor. In some embodiments, the MEMS sensor 108 may also be configured to measure a temperature within the vacuum dewar assembly 104.

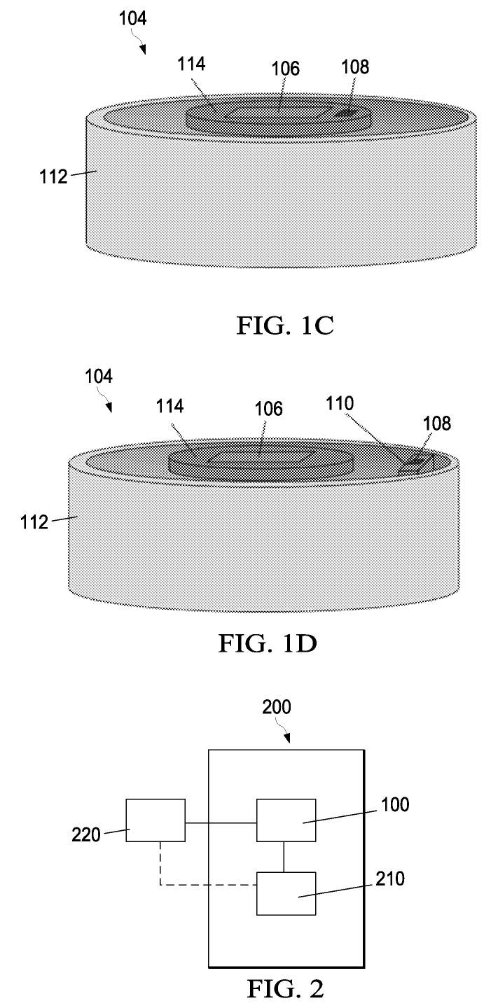

The vacuum dewar assembly 104 also includes a header/feedthrough assembly 110 that includes at least one hermetic electrical feedthrough in a lower vacuum assembly 112 configured to provide signals from the infrared SCA 106 and the sensor 108 to the exterior of the vacuum dewar assembly 104. For example, the signals may be provided to a control circuit, an external interface, etc. as described below with respect to FIG. 2. As can be seen in FIGS. 1B and 1C, the infrared SCA 106 and the sensor 108 may be mounted to a metalized platform 114, which interfaces with a thermal adapter 116 to provide cryogenic cooling from the cooler 102. However, in other embodiments, the sensor 108 may be mounted to a different location. For example, the sensor 108 may be mounted on a surface of header/feedthrough assembly 110 as shown in FIG. 1D, on an internal surface of the vacuum dewar assembly 104, etc.

The vacuum dewar assembly 104 also includes a cold shield assembly 118, which shields the SCA 106 from stray light. A window housing 120 may be included to enclose the dewar assembly 104, and which includes a window 122 to allow the infrared SCA 106 to detect infrared radiation, and a tip-off tube 124 to allow the pull of a vacuum on the vacuum dewar assembly 104 after assembly. In addition, the vacuum dewar assembly 104 may include a getter 126 to help maintain vacuum from internal outgassing.

Although FIGS. 1A through 1D illustrate one example of a dewar-cooler assembly 100, various changes may be made to FIGS. 1A through 1D. For example, while the dewar-cooler assembly 100 is illustrated as including particular components, the dewar-cooler assembly 100 could include additional components, certain components could be omitted, etc. according to particular needs. Also, while the components in the dewar-cooler assembly 100 are illustrated as having particular shapes and arrangements, the shapes, arrangements, etc. of the various components could be changed according to particular needs.

FIG. 2 illustrates an example schematic diagram for an infrared imaging assembly 200 in accordance with this disclosure. The infrared imaging assembly 200 represents one example of a system in which the dewar-cooler assembly 100 may be integrated. As can be seen in FIG. 2, the infrared imaging assembly 200 includes the dewar-cooler assembly 100, as well as a control circuit 210. The control circuit 210 can interface with the cooler assembly 100 to acquire measurement data from the sensor 108 and to control the cooler 102 based on the measurement data. In some embodiments, the control circuit 210 may be configured to prevent operation of the cooler 102 if the pressure level measured by the sensor 108 exceeds a predetermined pressure limit.

The infrared imaging assembly 200 also includes an external interface 220. The external interface 220 may be used, for example, to interface with at least one device or system in which the infrared imaging assembly 200 is integrated (such as a missile, an aircraft tracking pod, etc.). In other embodiments, the external interface 220 may be a diagnostic interface through which a technician may retrieve measurement data from the sensor 108. In some embodiments, the control circuit 210 may interface with the external interface 220. Also, in some embodiments, the control circuit 210 may transmit an error signal (such as via the external interface 220) if the pressure level measured by the sensor 108 exceeds a predetermined pressure or temperature limit. The error signal, for example, may cause an indication on an avionics display, diagnostic equipment, etc. that the infrared imaging assembly 100 is not operating within acceptable performance tolerances.

Although FIG. 2 illustrates one example of an infrared imaging assembly 200, various changes may be made to FIG. 2. For example, while the infrared imaging assembly 200 is illustrated as including particular components, the infrared imaging assembly 200 could include additional components, certain components could be omitted, etc. according to particular needs.

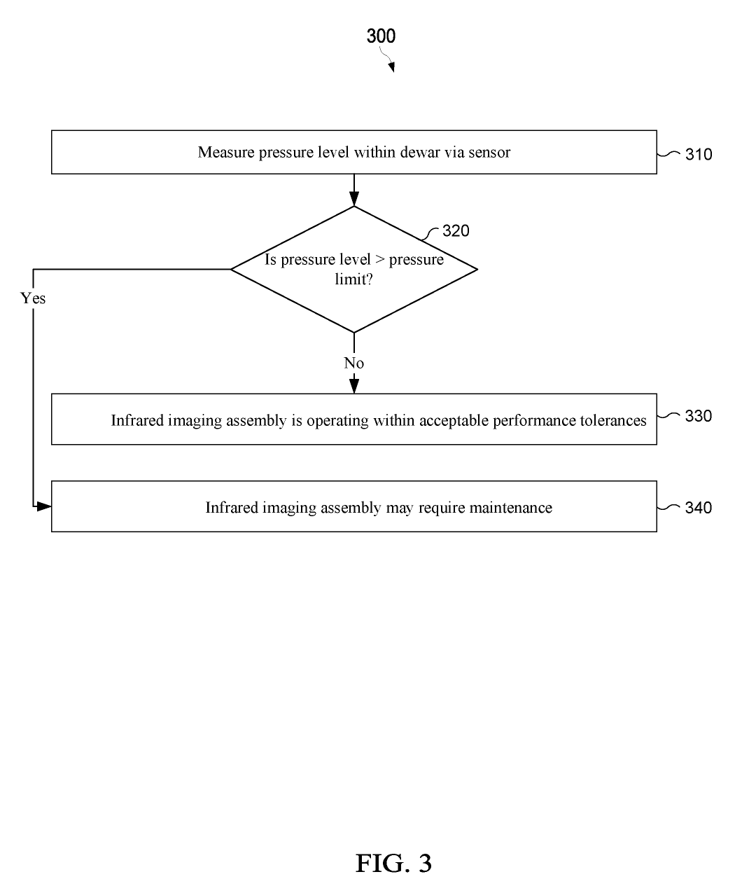

FIG. 3 illustrates an example method 300 of evaluating a vacuum status of an infrared imaging assembly in accordance with this disclosure. For ease of explanation, the method 300 shown in FIG. 3 may be described as involving the use of the infrared imaging assembly 200 shown in FIG. 2. However, the method 300 shown in FIG. 3 may be involve the use of any suitable device(s) and in any suitable system(s).

As shown in FIG. 3, at step 310, a measurement is performed (such as via a software routine, maintenance procedures, etc.), via a sensor (such as the sensor 108) housed within a vacuum dewar assembly (such as the vacuum dewar assembly 104) of an infrared imaging assembly (such as the infrared imaging assembly 200) to determine a pressure level within the vacuum dewar assembly. The measurement may be performed in a variety of scenarios. For example, the measurement may be performed during a benchtop maintenance check by a technician. Alternatively, the measurement could be performed by an internal diagnostic routine of a system in which the infrared imaging assembly is integrated, such as a missile, a tracking pod, etc. In some embodiments, the measurement may be a single measurement. In other embodiments, the measurement may be performed continuously (such as during an aircraft flight via the avionics).

At step 320, a determination is made (such as via a software routine, maintenance procedures, etc.) whether the pressure level within the vacuum dewar assembly exceeds a predetermined pressure limit. For example, failure may be expected at pressures above 1mTorr (~0.0013atm), which is the approximate crossover point between molecular flow (no convection in high vacuum) and viscous flow (convective heat transfer occurs among gaseous species). If the pressure level does not exceed the predetermined pressure limit, the method proceeds to step 330. If the pressure level exceeds the predetermined pressure limit, the method proceeds to step 340.

At step 330, a determination is made (such as via a software routine, maintenance procedures, cooldown test etc.) that the infrared imaging assembly is operating within acceptable performance tolerances. In response to the determination, an action may be initiated. For example, if the infrared imaging assembly includes a control circuit (such as control circuit 210), the control circuit may permit operation of a cooler such as cooler 102. At step 340, a determination is made (such as via a software routine, maintenance procedures, cooldown test, etc.) that the infrared imaging assembly may require maintenance. In response to the determination, an action may be initiated. For example, if the infrared imaging assembly includes a control circuit (such as control circuit 210), the control circuit may prevent operation of a cooler such as cooler 102, transmit an error signal, etc.

Although FIG. 3 illustrates one example of a method 300 of evaluating a vacuum status of an infrared imaging assembly, various changes may be made to FIG. 3. For example, while shown as a series of steps, various steps in FIG. 3 could overlap, occur in parallel, occur in a different order, or occur any number of times (including zero times).

In some embodiments, various functions described in this patent document are implemented or supported by a computer program or other program that is formed from computer readable program code or instructions and that is embodied in a computer or machine readable medium. The phrases “computer readable program code” and “instructions” include any type of code, including source code, object code, and executable code. The phrases “computer readable medium” and “machine readable medium” include any type of medium capable of being accessed by a computer or other machine, such as read only memory (ROM), random access memory (RAM), a hard disk drive (HDD), a compact disc (CD), a digital video disc (DVD), or any other type of memory. A “non-transitory” computer or machine readable medium excludes wired, wireless, optical, or other communication links that transport transitory electrical or other signals. A non-transitory computer or machine readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An infrared imaging assembly comprising:
a vacuum dewar assembly;
an infrared sensor chip assembly (SCA) housed within the vacuum dewar assembly;
a sensor housed within the vacuum dewar assembly and configured to measure a pressure level within the vacuum dewar assembly; and
a cooler configured to provide a cryogenic SCA temperature within the vacuum dewar assembly.

2. The infrared imaging assembly of claim 1, wherein the sensor is one of a micro-electro-mechanical system (MEMS) Pirani gauge or a MEMS ionization gauge.

3. The infrared imaging assembly of claim 1, wherein the infrared SCA and the sensor are jointly mounted to a platform internal to the vacuum dewar assembly.

4. The infrared imaging assembly of claim 1, wherein the sensor is mounted to an internal surface of the vacuum dewar assembly other than an SCA platform.

5. The infrared imaging assembly of claim 1, further comprising a control circuit configured to at least one of:
prevent operation of the cooler if a pressure level measured by the sensor exceeds a predetermined pressure limit; and
transmit an error signal if the pressure level measured by the sensor exceeds the predetermined pressure limit.

6. The infrared imaging assembly of claim 1, wherein the sensor is further configured to measure a temperature within the vacuum dewar assembly.

7. The infrared imaging assembly of claim 1, further comprising at least one electrical feedthrough configured to provide a signal from the sensor to an exterior of the vacuum dewar assembly.

8. A vacuum dewar assembly for an infrared imaging assembly, the vacuum dewar assembly comprising:
an infrared sensor chip assembly (SCA) housed within the vacuum dewar assembly; and
a sensor housed within the vacuum dewar assembly and configured to measure a pressure level within the vacuum dewar assembly.

9. The vacuum dewar assembly of claim 8, wherein the sensor is one of a micro-electro-mechanical system (MEMS) Pirani gauge or a MEMS ionization gauge.

10. The vacuum dewar assembly of claim 8, wherein the infrared SCA and the sensor are jointly mounted to a platform internal to the vacuum dewar assembly.

11. The vacuum dewar assembly of claim 8, wherein the sensor is mounted to an internal surface of the vacuum dewar assembly other than an SCA platform.

12. The vacuum dewar assembly of claim 8, wherein the sensor is further configured to measure a temperature within the vacuum dewar assembly.

13. The vacuum dewar assembly of claim 8, further comprising at least one electrical feedthrough configured to provide a signal from the sensor to an exterior of the vacuum dewar assembly.

14. A method comprising:
measuring, via a sensor housed within a vacuum dewar assembly of an infrared imaging assembly, a pressure level within the vacuum dewar assembly;
determining whether the pressure level within the vacuum dewar assembly exceeds a predetermined pressure limit; and
in response to a determination that the pressure level within the vacuum dewar assembly exceeds the predetermined pressure limit, initiating an action.

15. The method of claim 14, wherein the action is transmitting an error signal.

16. The method of claim 14, wherein the sensor is one of a micro-electro-mechanical system (MEMS) Pirani gauge or a MEMS ionization gauge.

17. The method of claim 14, wherein the infrared imaging assembly comprises:
the vacuum dewar assembly;
an infrared sensor chip assembly (SCA), housed within the vacuum dewar assembly;
the sensor; and
a cooler configured to provide a cryogenic SCA temperature within the vacuum dewar assembly.

18. The method of claim 15, wherein the sensor is further configured to measure a temperature within the vacuum dewar assembly.

19. The method of claim 16 further comprising:
measuring, via the sensor, a temperature within the vacuum dewar assembly;
determining whether the temperature within the vacuum dewar assembly exceeds a predetermined temperature limit; and
in response to a determination that the temperature within the vacuum dewar assembly exceeds the predetermined temperature limit, initiating an action.

20. The method of claim 19, wherein the action is transmitting an error signal.
